(19) United States
(12) Patent Application Publication
(10) Pub. No.: US 2021/0026901 A1
(43) Pub. Date: Jan. 28, 2021

(54) SYSTEMS AND METHODS FOR GENERATING SEARCH SUGGESTIONS FOR A SEARCH QUERY OF MULTIPLE ENTITIES

(71) Applicant: Rovi Guides, Inc., San Jose, CA (US)

(72) Inventors: Ankur Anil Aher, Kalyan (IN); Aman Puniyani, Rohtak (IN)

(21) Appl. No.: 16/523,881

(22) Filed: Jul. 26, 2019

(51) Int. Cl. G06F 16/903; H04N 21/422; G06F 16/9032; G06F 16/908; G06F 16/9035; H04N 21/472

(52) U.S. Cl. CPC G06F 16/90344; H04N 21/42203; H04N 21/47202; G06F 16/908; G06F 16/9035; G06F 16/90328

(57) ABSTRACT

Systems and methods are disclosed herein for generating search suggestions for a search query of multiple entities. The disclosed techniques herein discuss a determination made for whether the primary search term is associated with a plurality of entities. In a positive determination, for each respective entity of the plurality of entities, firstly, a metadata identifier is determined. The metadata identifier is unique among each of the plurality of entities other than the respective entity. Secondly, a suggested search string is generated including search string elements that include the primary search term, the entity, and the metadata identifier. Generation of audio or display of the suggested search string is output.

### BACKGROUND

The present disclosure is directed to techniques for generating search suggestions, more particularly, generating search suggestions of a search query of multiple entities.

### SUMMARY

Searches often involve an iterative process of narrowing queries in a chain before arriving at a desired set of final results. This is especially true with voice-based searches. Current approaches provide for the most popular or relevant search results based on a primary search term of a search query. If the primary search term has many different types of entities (e.g. a primary search term “Warrior” may refer to a basketball team, movie, song, or other type of entity), the diversity of search suggestions/results may be narrow, as the search suggestions/results prioritize popularity and/or relevance. Providing search suggestions without multiple search iterations remains technically challenging, as these current approaches do not create unique search suggestions ensuring a diversity of entity types of a primary search term of the search query.

Accordingly, techniques are disclosed herein for generating search suggestions for a search query of multiple entities. A primary search term is identified from a received search query (e.g. a voice query). A determination is made whether the primary search term is associated with a plurality of entities. In a positive determination, for each respective entity of the plurality of entities, firstly, a metadata identifier is determined. The metadata identifier is unique among each of the plurality of entities other than the respective entity. Secondly, a suggested search string is generated including search string elements that include the primary search term, the entity, and the metadata identifier. Generation of audio or display of the suggested search string is output.

In some embodiments, determining the metadata identifier for the respective entity includes receiving metadata for the entity. The metadata includes, for each respective metadata category, a metadata category and a category value. The technique determines whether at least one category value of a respective metadata category for the entity is unique among category values for the respective metadata category of all other entities. In other embodiments, the technique determines whether received user profile data matches any of the received metadata for the entity. If the received user profile data matches any of the received metadata for the entity, the matching user profile data is included in the plurality of the search string elements. In yet other embodiments, in response to the determination that at least one category value of the respective metadata category for the entity is not unique among category values for the respective metadata category of all other entities, a second determination is made of whether at least two category values of respective metadata categories for the entity are unique among two categories values for the respective metadata categories of all other entities.

In some embodiments, historical suggested search string selections are retrieved from a data structure. A common format of the historical suggested search string selections is determined. The technique determines an order of the plurality of search string elements based on the determined common format of the suggested search string selections. The historical suggested search string selections may be retrieved from a user profile of a user who initiated the received search query.

The disclosed techniques for generating search suggestions for a search query of multiple entities reduce the iterative process of narrowing queries in a search chain. The appropriate entity may be selected from a plurality of suggested search strings, each of the suggested search strings having diverse entities, which narrows the number of queries in the search chain.

### BRIEF DESCRIPTION OF THE DRAWINGS

The below and other objects and advantages of the disclosure will be apparent upon consideration of the following detailed description, taken in conjunction with the accompanying drawings, in which like reference characters refer to like parts throughout, and in which:

FIG. 1 shows an illustrative diagram of metadata for a plurality of entities of a search query, in accordance with some embodiments of the disclosure;

FIG. 2A shows an illustrative diagram of a voice search, in accordance with some embodiments of the disclosure;

FIG. 2B shows an illustrative diagram of suggested search strings responsive to a voice search, in accordance with some embodiments of the disclosure;

FIG. 2C shows an illustrative diagram of a follow-up voice search, in accordance with some embodiments of the disclosure;

FIG. 2D shows an illustrative diagram of a selected suggested search suggestion, in accordance with some embodiments of the disclosure;

FIG. 3 shows an illustrative system diagram of the processing engine, streaming service server, and multiple electronic devices, in accordance with some embodiments of the disclosure;

FIG. 4 shows an illustrative block diagram of the processing engine, in accordance with some embodiments of the disclosure;

FIG. 5 is an illustrative flowchart of a process for generating search suggestions for a search query of multiple entities, in accordance with some embodiments of the disclosure; and

FIG. 6 is an illustrative flowchart of a process for determining the metadata identifier for the respective entity, in accordance with some embodiments of the disclosure.

### DETAILED DESCRIPTION

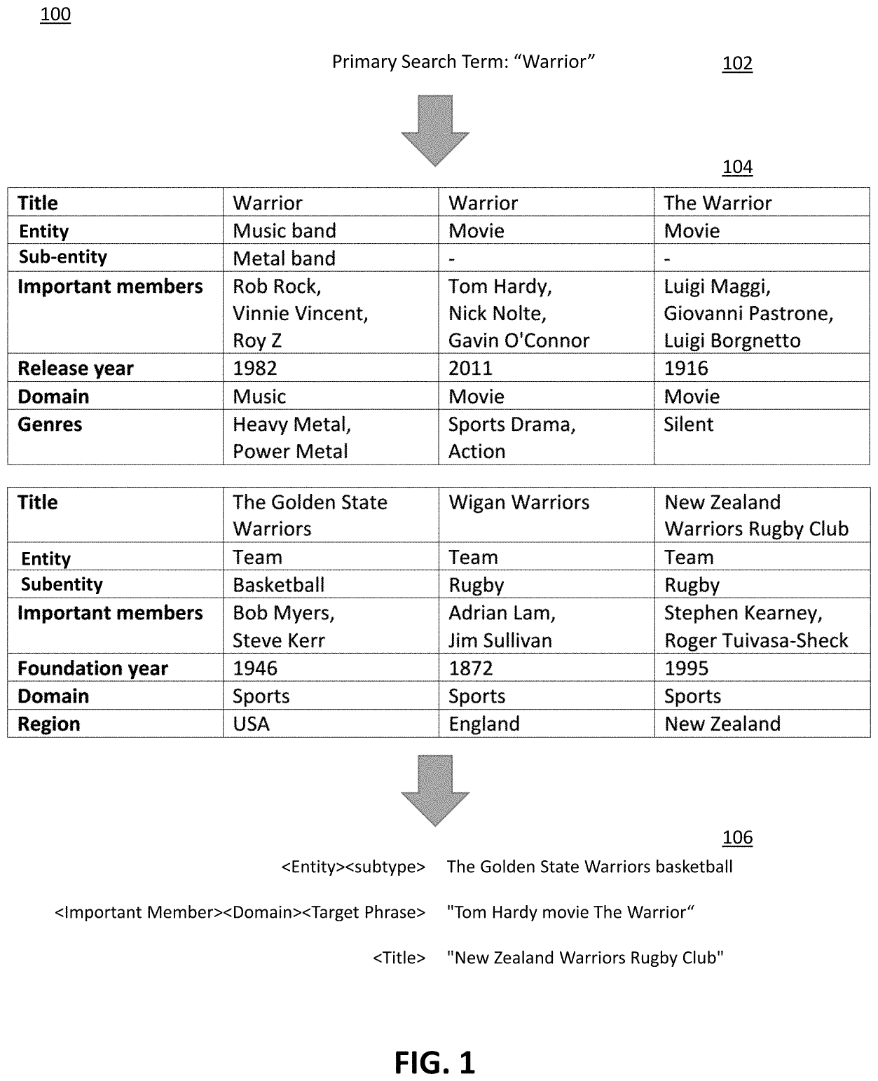

FIG. 1 shows an illustrative diagram 100 of metadata for a plurality of entities of a search query, in accordance with some embodiments of the disclosure. In this example, a primary search term “Warrior” 102 is identified from a search query by a processing engine. The processing engine may receive the metadata of a plurality of entities from memory (e.g. storage, a database, a streaming service server, etc.). The table 104 lists the entity and other categories such as title, sub-entity, important members, release year, domain, and genres. Many other fields may be applicable for any type of media asset or digital information. The processing engine may determine a metadata identifier for the respective entity. A metadata identifier is unique among each of the plurality of entities other than the respective entity. For example, the release year has value “1982” for entity “Music band.” This year “1982” is unique among all entities that matched the primary search term “Warrior.” The processing engine may generate a suggested search string comprising a plurality of search string elements 106, wherein the plurality of search string elements includes the primary search term, the entity, and the metadata identifier. For example, a generated search string includes “The Golden State Warriors basketball” having the primary search term “Warrior,” the entity “Team,” and a metadata identifier “basketball.”

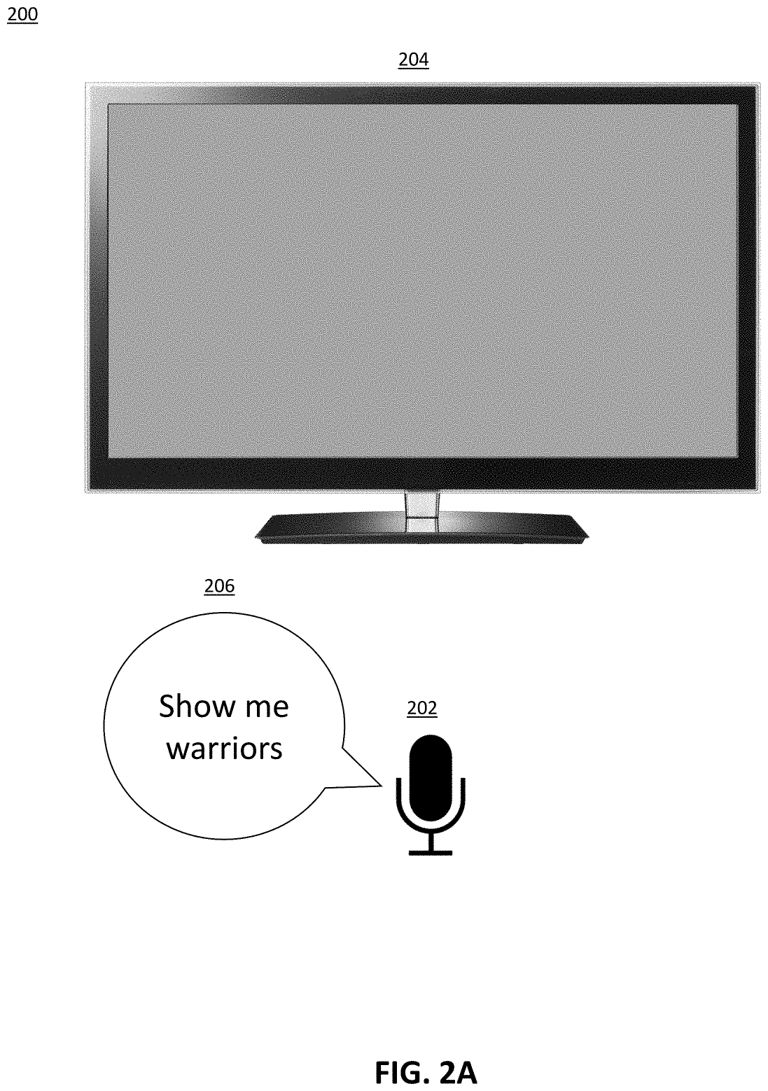

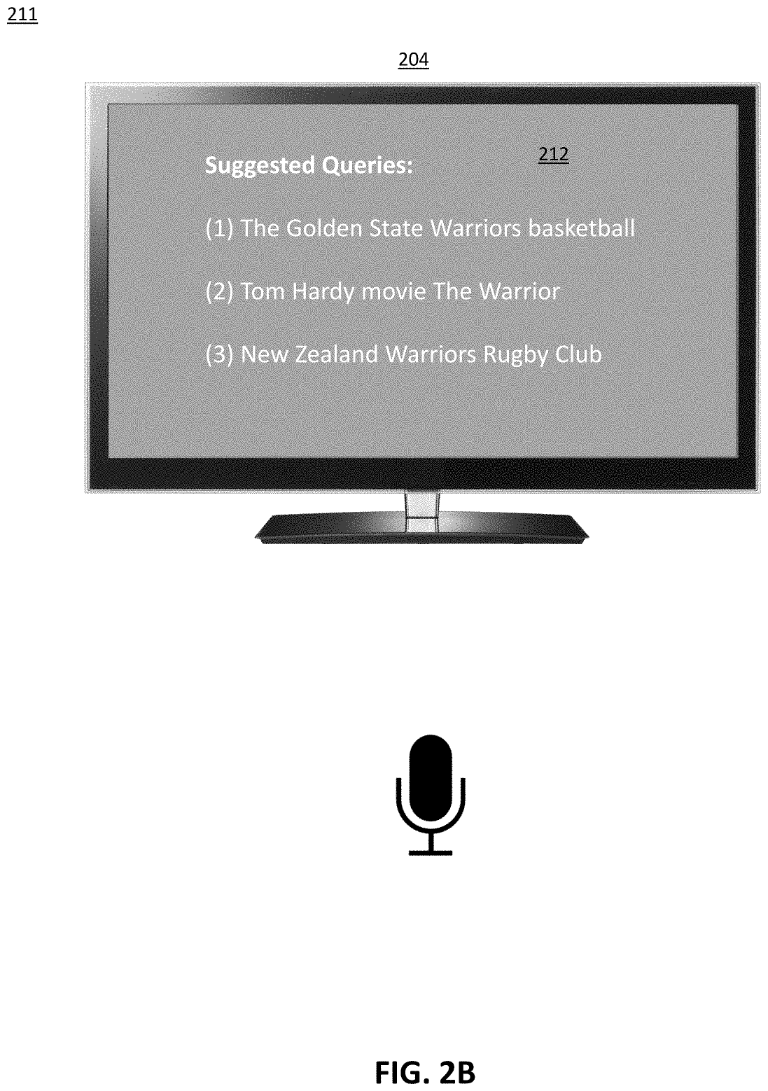

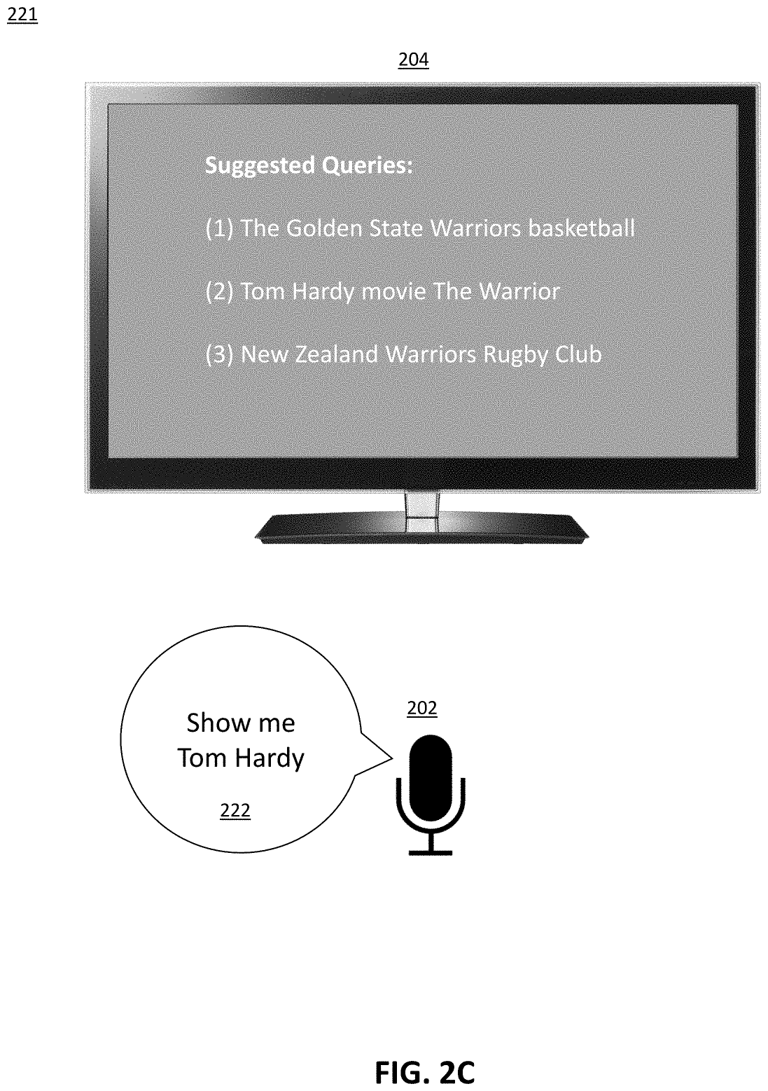

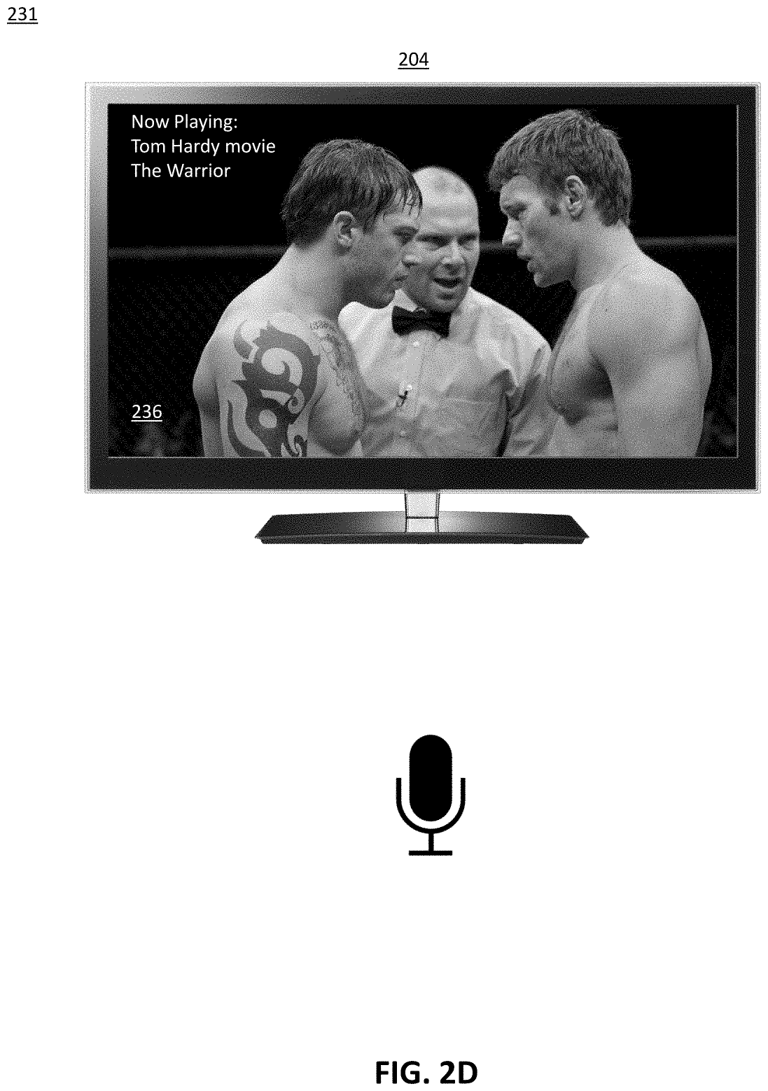

FIG. 2A shows an illustrative diagram 200 of a voice search, in accordance with some embodiments of the disclosure. The processing engine 204 (e.g. a smart television) may identify a primary search term from a received search query. For example, a voice query 206 is received from a smartphone microphone input 202 stating “Show me warriors.” The smartphone may be connected to the smart television via a communication network such as Wi-Fi networking.

In some embodiments, the processing engine may parse the voice query into one or more keywords. Parsing digital voice data into one or more keywords may be implemented by various techniques known to one of ordinary skill in the art. The processing engine may then identify a primary search term from the one or more keywords derived from the parsing. In some embodiments, the processing engine may determine a primary search term from the parsed one or more keywords by applying relevance algorithms to the one or more keywords to select a primary search term. For example, leading verbs such as “show” or “pull up” are generally given lower weights for ranking words in weighted relevance mathematical algorithms unless the words match leading words of a media asset.

The processing engine may determine whether the primary search term is associated with a plurality of entities. In some embodiments, the processing engine may receive information from a streaming server regarding information (e.g. metadata) of media assets for streaming on the streaming service server. Continuing from the example above, a primary search term “Warrior” is associated with three entities shown in 104, namely Music Band, Movie, and Team.

The processing engine, in response to the determination that the primary search term is associated with the plurality of entities, for each respective entity of the plurality of entities, may determine a metadata identifier for the respective entity. The metadata identifier is unique among each of the plurality of entities other than the respective entity. Continuing from the example above using table 104, a unique metadata identifier may be found in the metadata category “important members,” where the actor “Tom Hardy” shows the movie Warrior starring Tom Hardy released in 2011. The actor “Tom Hardy” is not used in any other of the five entities.

In some embodiments, determining the metadata identifier for the respective entity includes the processing engine receiving metadata for the entity. The metadata comprises, for each respective metadata category, a metadata category and a category value. Continuing from the above example using table 104, the bolded text represents the categories, while the plain formatted text represents the category values. For example, for entity music band, the “Entity” is the metadata category, while “Music Band” is the metadata value for the respective category of “Entity.” The processing engine may also determine whether at least one category value of a respective metadata category for the entity is unique among category values for the respective metadata category of all other entities. For example, the metadata value “Music Band” for metadata category “Entity” is unique for all entities. There are no other entities which have the value “Music Band.” In some embodiments, the processing engine retrieves user profile data. The profile data may be retrieved from storage within the processing engine, a streaming service server, or another third-party database communicatively coupled to the processing engine. The processing engine determines whether the user profile data matches any of the received metadata for the entity. In response to the determination that the user profile data matches any of the received metadata for the entity, the processing engine includes the matching user profile data in the plurality of the search string elements. The term “matching,” used throughout the specification, may include an equivalency in value or may include a number of values that constitute a match within a specified threshold. For example, if the user profile data shows that the user has previously searched for Tom Hardy multiple times, and/or follows Tom Hardy on social media platforms (e.g. Twitter® and/or Instagram®), the processing engine will include Tom Hardy in the suggested search string “(2) Tom Hardy movie The Warrior.”

In other embodiments, in response to the determination that at least one category value of the respective metadata category for the entity is not unique among category values for the respective metadata category of all other entities, the processing engine may determine whether at least two category values of respective metadata categories for the entity is unique among two categories values for the respective metadata categories of all other entities. Continuing from the above example using table 104, the entry for The Warrior starting Tom Hardy released in 2011 shares a metadata value “Movie” for metadata category “Entity” with The Warrior starting Luigi Maggi released in 1916. The processing engine may then determine another metadata value for another respective metadata category for uniqueness. Namely, the processing engine may determine under “Important Members” metadata category, “Tom Hardy” is unique to “Luigi Maggi.” Thus, the values of “Movie” and “Tom Hardy” (two category values) are unique among these two categories values for the respective metadata categories of all other entities.

The processing engine, in response to the determination that the primary search term is associated with the plurality of entities, for each respective entity of the plurality of entities, may generate a suggested search string comprising a plurality of search string elements. The plurality of search string elements may include the primary search term, the entity, and the metadata identifier. Continuing from the example above using table 104, the search string elements include primary search term “The Warrior,” entity “movie,” and metadata identifier “Tom Hardy.” FIG. 2B shows an illustrative diagram 211 of suggested search strings responsive to a voice search, in accordance with some embodiments of the disclosure. In this example, a plurality of suggested search strings 212 are generated for output to the smart television 204 screen showing “(1) The Golden State Warriors basketball,” “(2) Tom Hardy movie The Warrior,” and “(3) New Zealand Warriors Rugby Club.” In some embodiments, the suggested search strings are generated for audio output. The generated audio output may be played back on the processing engine (e.g. smart TV), or alternatively on the device (e.g. smartphone). In such an embodiment, the smartphone would use the speaker to play a narrated version of the suggested search strings.

FIG. 2C shows an illustrative diagram 221 of a follow-up voice search, in accordance with some embodiments of the disclosure. After listing the plurality of suggested search strings, a second voice input 222 “Show me Tom Hardy” is received by the processing engine 204. The processing engine associates the voice input containing “Tom Hardy” with the suggested search string of “(2) Tom Hardy movie The Warrior.”

FIG. 2D shows an illustrative diagram 231 of a selected suggested search suggestion, in accordance with some embodiments of the disclosure. The processing engine may generate for display 236 the media asset associated with the suggested search string of “(2) Tom Hardy movie The Warrior.”

In some embodiments, the processing engine may retrieve historical suggested search string selections from a data structure. The data structure may be storage within the processing engine, a streaming service server, or another third-party database communicatively coupled to the processing engine. The historical suggested search string selections may be retrieved for a specific user profile, user profiles, or demographic profile (e.g. time-, gender-based, age-based, influencer-based, social media trend-based, etc.). In some embodiments, the historical suggested search string selections may be retrieved by the processing engine for a specific user profile of a user which initiated the search query. For example, the device ID of the device of the user who initiated the search query may be used to retrieve historical suggested search string selections from the device (or alternatively, device ID may be used to identify the user with a third-party database for information retrieval).

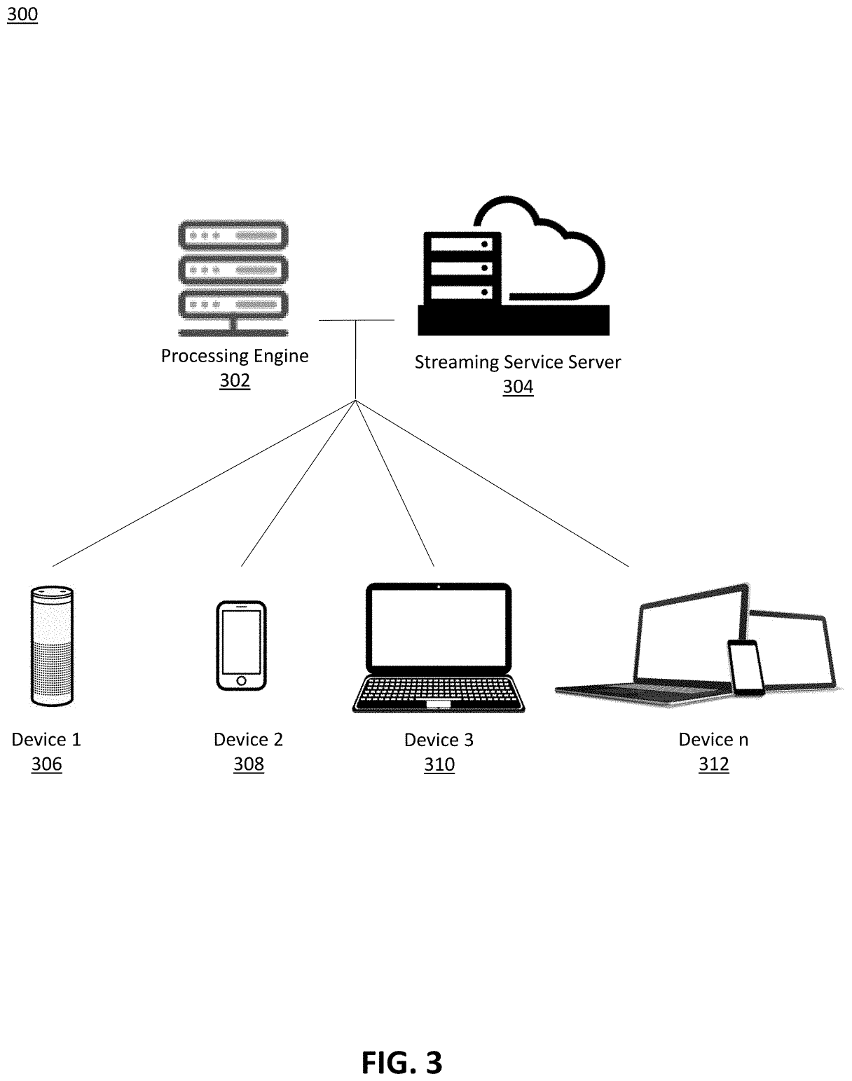

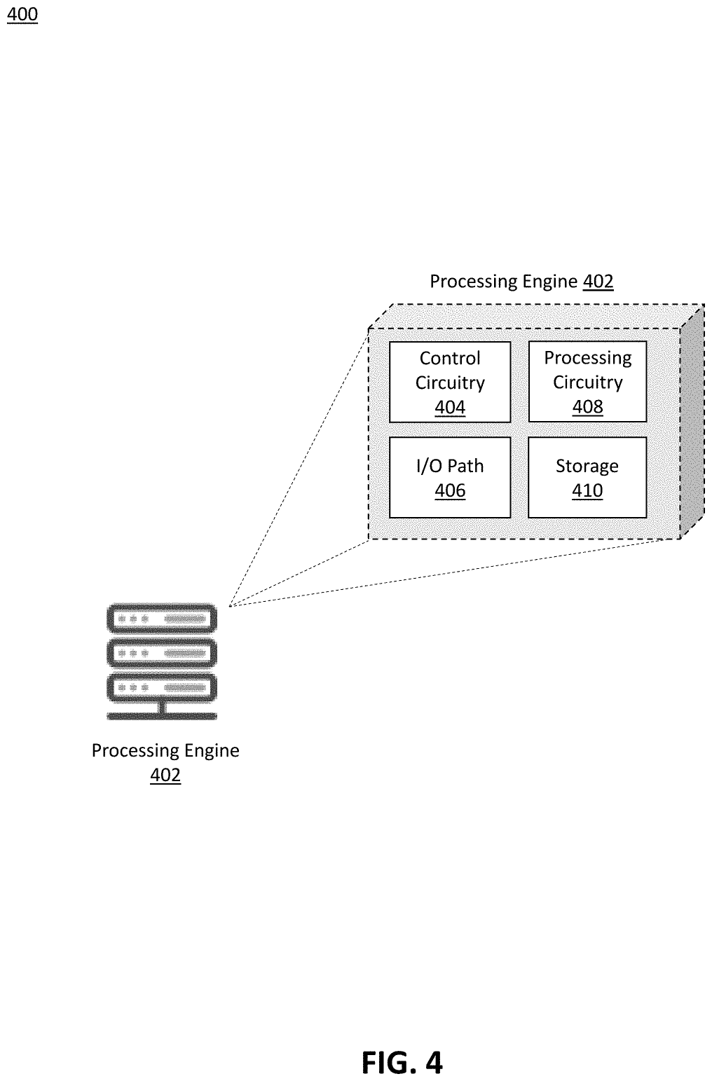

FIG. 3 shows an illustrative system diagram 300 of the processing engine, streaming service server, and multiple electronic devices, in accordance with some embodiments of the disclosure. The processing engine 302 may be of any hardware that provides for processing and transmit/receive functionality. In some embodiments, the processing engine includes hardware designed for voice parsing operations. The processing engine may be communicatively coupled to multiple electronic devices (e.g. device 1 (306), device 2 (308), device 3 (310), and device n (312)), and a streaming service server 304. As illustrated within FIG. 3, a further detailed disclosure on the processing engine can be seen in FIG. 4 showing an illustrative block diagram of the processing engine, in accordance with some embodiments of the disclosure.

In some embodiments, the processing engine may be implemented remote from the devices 306-312 such as from a cloud server configuration. The processing engine may be any device for receiving information from the devices 306-312 and identifying and/or parsing voice/video and other information from the devices and/or media content streaming from the streaming service server 304. The processing engine may be implemented by a remote server, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a smart-home personal assistant, a laptop computer, a tablet computer, a WebTV box, a personal computer television (PC/TV), a PC media server, a PC media center, a handheld computer, a stationary telephone, a personal digital assistant (PDA), a mobile telephone, a portable video player, a portable music player, a portable gaming machine, a smart phone, or any other television equipment, computing equipment, Internet-of-Things device, wearable device, or wireless device, and/or combination of the same. Any of the system modules (e.g., processing engine, streaming service server, and electronic devices) may be any combination of shared or disparate hardware pieces that are communicatively coupled.

In some embodiments, the streaming service server may be implemented remote from the electronic devices 306-312 and the processing engine 302 such as a cloud server configuration. The streaming service server may be any device interfacing with the processing engine for provision of media assets/media asset information (e.g. metadata). In some embodiments, the streaming service server provides the media assets/information via streaming format over a communication network (e.g., Internet, Bluetooth, NFC, or similar). In some embodiments, the streaming service server provides permissions for a user account to access media assets/information on local storage. The streaming service server may be implemented by remote servers, remote databases, a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a personal computer television (PC/TV), a PC media server, a PC media center, a handheld computer, a stationary telephone, a personal digital assistant (PDA), a mobile telephone, a portable video player, a portable music player, a portable gaming machine, a smart phone, or any other television equipment, computing equipment, Internet-of-Things device, wearable device, or wireless device, and/or combination of the same.

In some embodiments, the processing engine, streaming service server, and a device from devices 306-312 may be implemented within a single local device. In other embodiments, the processing engine and streaming service server may be implemented within a single local device.

The electronic devices (e.g. device 1 (306), device 2 (308), device 3 (310), and device n (312)), may be any device that has properties to transmit/receive network data as well as provide information for a search query and commands in relation to search queries. Provision of information may be through audio, video, gesture, or other recognizable interface to one of ordinary skill in the art. The devices 306-312 may be implemented by a camera, video camera, microphone, smart-glasses, smart watch, television, a Smart TV, a set-top box, an integrated receiver decoder (IRD) for handling satellite television, a digital storage device, a digital media receiver (DMR), a digital media adapter (DMA), a streaming media device, a personal computer (PC), a laptop computer, a tablet computer, a WebTV box, a personal computer television (PC/TV), a PC media server, a PC media center, a handheld computer, a stationary telephone, a mobile telephone, a portable video player, a portable music player, a portable gaming machine, a smart phone, or any other television equipment, computing equipment, Internet-of-Things device, wearable device, or wireless device, and/or combination of the same.

FIG. 4 shows an illustrative block diagram 400 of the processing engine, in accordance with some embodiments of the disclosure. In some embodiments, the processing engine may be communicatively connected to a user interface. In some embodiments, the processing engine may include processing circuitry, control circuitry, and storage (e.g. RAM, ROM, hard disk, removable disk, etc.). The processing engine may include an input/output path 406. I/O path 406 may provide device information, or other data, over a local area network (LAN) or wide area network (WAN), and/or other content and data to control circuitry 404, that includes processing circuitry 408 and storage 410. Control circuitry 404 may be used to send and receive commands, requests, signals (digital and analog), and other suitable data using I/O path 406. I/O path 406 may connect control circuitry 404 (and specifically processing circuitry 408) to one or more communications paths.

Control circuitry 404 may be based on any suitable processing circuitry such as processing circuitry 408. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g. dual-core, quad-core, hexa-core, or any suitable number of cores) or supercomputer. In some embodiments, processing circuitry may be distributed across multiple separate processors or processing units, for example, multiple of the same type of processing units (e.g. two Intel Core i7 processors) or multiple different processors (e.g. an Intel Core i5 processor and an Intel Core i7 processor). In some embodiments, control circuitry 404 executes instructions for a processing engine stored in memory (e.g. storage 410). In some embodiments, the processing circuitry may utilize hardware specifically for parsing voice inputs into one or more keywords (e.g., Texas Instruments PCM3070).

Memory may be an electronic storage device provided as storage 410, which is part of control circuitry 404. As referred to herein, the phrase “electronic storage device” or “storage device” should be understood to mean any device for storing electronic data, computer software, or firmware, such as random-access memory, read-only memory, hard drives, solid state devices, quantum storage devices, or any other suitable fixed or removable storage devices, and/or any combination of the same. Nonvolatile memory may also be used (e.g., to launch a boot-up routine and other instructions).

The processing engine 402 may be coupled to a communications network. The communication network may be one or more networks including the Internet, a mobile phone network, mobile voice or data network (e.g. a 5G, 4G or LTE network), mesh network, peer-to-peer network, cable network, or other types of communications network or combinations of communications networks. The processing engine may be coupled to a secondary communication network (e.g. Bluetooth, Near Field Communication, service provider proprietary networks, or wired connection) to the selected device for generation for playback. Paths may separately or together include one or more communications paths, such as a satellite path, a fiber-optic path, a cable path, a path that supports Internet communications, free-space connections (e.g. for broadcast or other wireless signals), or any other suitable wired or wireless communications path or combination of such paths.

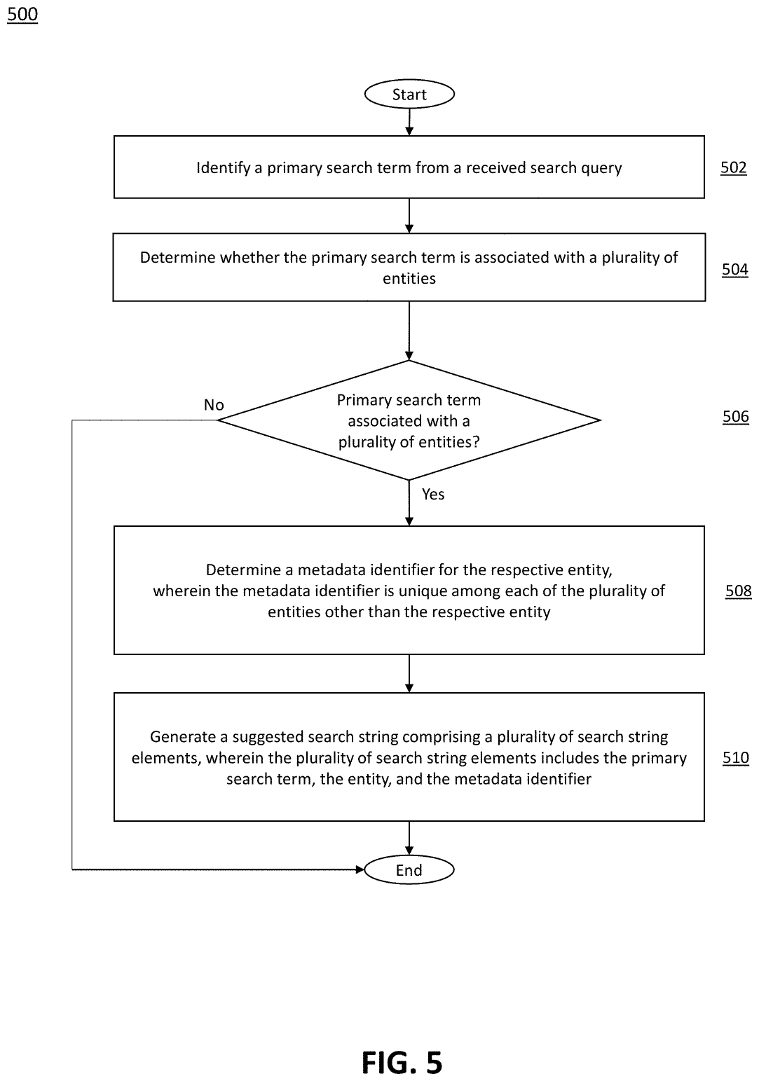

FIG. 5 is an illustrative flowchart of a process for generating search suggestions for a search query of multiple entities, in accordance with some embodiments of the disclosure. Process 500, and any of the following processes, may be executed by control circuitry 404 (e.g. in a manner instructed to control circuitry 404 by the processing engine 402). Control circuitry 404 may be part of a processing engine, or of a remote server separated from the processing engine by way of a communication network, or distributed over a combination of both.

At 502, the processing engine 302, by control circuitry 404, identifies a primary search term from a received search query. In some embodiments, the processing engine 302, by control circuitry 404, receives the search query from devices 306-312 via the I/O path 406, where the devices provide the search query. In some embodiments, the search query is a voice query and thus voice data is received by the processing engine. In some embodiments, the search query is initiated by a user of the user profile retrieved from the devices 306-312 via the I/O path 406.

At 504, the processing engine 302, by control circuitry 404, determines whether the primary search term is associated with a plurality of entities. In some embodiments, the determining of whether the primary search term is associated with a plurality of entities is performed, at least in part, by processing circuitry 408. In other embodiments, the processing engine 302, by control circuitry 404, parses a voice input into one or more keywords to determine the primary search term associated with a plurality of entities. The parsing of the voice input into one or more keywords is performed, at least in part, by processing circuitry 408. If, at 506, control circuitry determines “No,” the primary search term is not associated with a plurality of entities, the process advances to END.

If, at 506, control circuitry determines “Yes,” the primary search term is associated with a plurality of entities, the process advances to 508. At 508, the processing engine 302, by control circuitry 404, determines a metadata identifier for the respective entity. The metadata identifier is unique among each of the plurality of entities other than the respective entity. In some embodiments, the processing engine 302, by control circuitry 404, receives metadata information from a streaming service 304 via the I/O path 406.

At 510, the processing engine 302, by control circuitry 404, generates a suggested search string comprising a plurality of search string elements. The plurality of search string elements includes the primary search term, the entity, and the metadata identifier. In some embodiments, generating a suggested search string comprising a plurality of search string elements is performed, at least in part, by processing circuitry 408. In some embodiments, the processing engine 302, by control circuitry 404, generates for audio output the suggested search string. The processing engine 302, by control circuitry 404, transmits the generated audio output to the devices 306-312 via the I/O path 406. In yet other embodiments, the processing engine 302, by control circuitry 404, generates for display the suggested search string. The processing engine 302, by control circuitry 404, transmits the generated suggested search string to the devices 306-312 via the I/O path 406. In some embodiments, the processing engine 302, by control circuitry 404, retrieves historical suggested search string selections from a data structure (e.g. storage 410, or a database connected via I/O path 406). The processing engine 302, by control circuitry 404, determines a common format of the historical suggested search string selections, and then determines an order of the plurality of search string elements based on the determined common format of the suggested search string selections. The historical suggested search string selections are retrieved for a user profile. In some embodiments, the processing engine 302, by control circuitry 404, retrieves the user profile from the streaming service 304 via the I/O path 406.

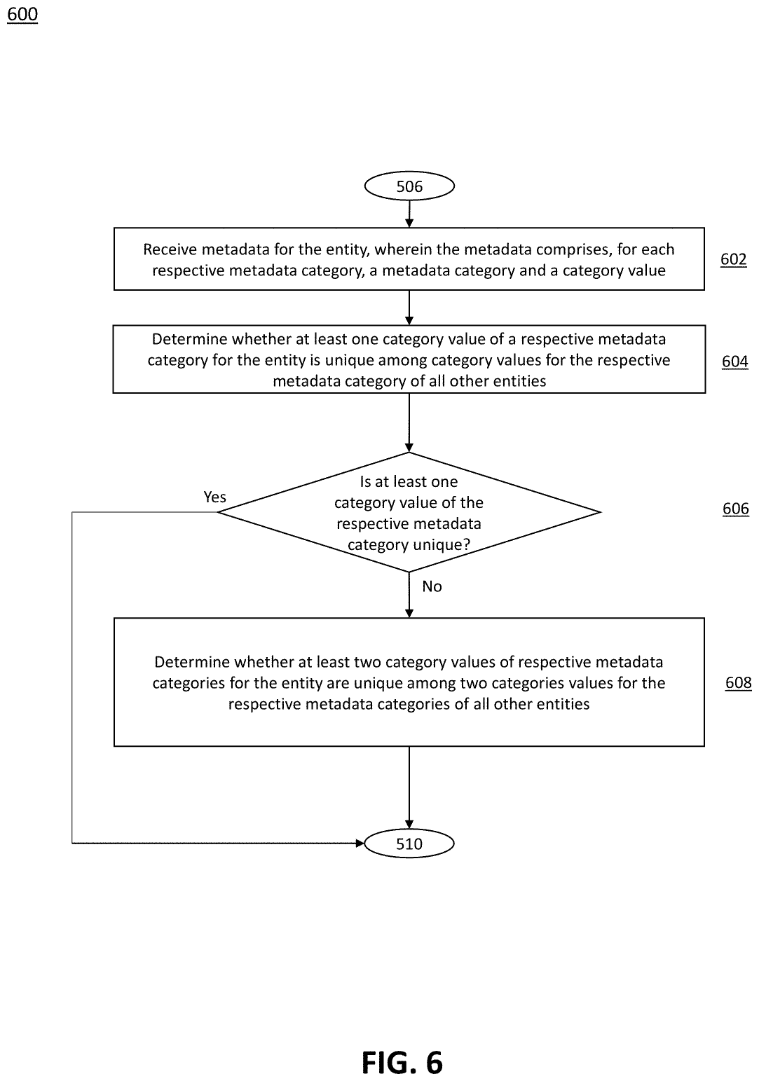

FIG. 6 is an illustrative flowchart of a process for determining the metadata identifier for the respective entity, in accordance with some embodiments of the disclosure. At 602, the processing engine 302, by control circuitry 404, receives metadata for the entity. The metadata comprises, for each respective metadata category, a metadata category and a category value. In some embodiments, the processing engine 302, by control circuitry 404, receives metadata for the entity from a streaming service 304 via the I/O path 406. In some embodiments, the processing engine 302, by control circuitry 404, retrieving user profile data from a data structure (e.g. storage 410, or a database connected via I/O path 406). The processing engine 302, by control circuitry 404, determines whether the user profile data matches any of the received metadata for the entity. The processing engine 302, by control circuitry 404, in response to the determination that the user profile data matches any of the received metadata for the entity, includes the matching user profile data in the plurality of the search string elements.

At 604, the processing engine 302, by control circuitry 404, determines whether at least one category value of a respective metadata category for the entity is unique among category values for the respective metadata category of all other entities. In some embodiments, the determining of whether at least one category value of a respective metadata category for the entity is unique among category values for the respective metadata category of all other entities is performed, at least in part, by processing circuitry 408. If, at 606, control circuitry determines “Yes,” at least one category value of a respective metadata category for the entity is unique among category values for the respective metadata category of all other entities, the process advances to END.

If, at 606, control circuitry determines “No,” at least one category value of a respective metadata category for the entity is not unique among category values for the respective metadata category of all other entities, the process advances to 608. At 608, the processing engine 302, by control circuitry 404, determines whether at least two category values of respective metadata categories for the entity is unique among two categories values for the respective metadata categories of all other entities. In some embodiments, the determining of whether at least two category values of respective metadata categories for the entity is unique among two categories values for the respective metadata categories of all other entities is performed, at least in part, by processing circuitry 408.

At 608, the processing engine 302, by control circuitry 404, determines whether one action of the plurality of baseline user actions matches an abnormal behavior model. In some embodiments, the processing engine 302 may receive an abnormal behavior model from devices 306-312 or streaming service server 304 via the I/O path 406. If, at 610, control circuitry determines “No,” the baseline user action does not match an abnormal behavior model, the process advances to 612. At 612, the processing engine 302, by control circuitry 404, iterates to next action of the plurality of baseline user actions to determine whether one action of the plurality of baseline user actions matches an abnormal behavior model.

It is contemplated that some suitable steps or suitable descriptions of FIGS. 5-6 may be used with other suitable embodiment of this disclosure. In addition, some suitable steps and descriptions described in relation to FIGS. 5-6 may be implemented in alternative orders or in parallel to further the purposes of this disclosure. For example, some suitable steps may be performed in any order or in parallel or substantially simultaneously to reduce lag or increase the speed of the system or method. Some suitable steps may also be skipped or omitted from the process. Furthermore, it should be noted that some suitable devices or equipment discussed in relation to FIGS. 3-4 could be used to perform one or more of the steps in FIGS. 5-6.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method for generating search suggestions for a search query of multiple entities, the method comprising:
identifying a primary search term from a received search query;
determining whether the primary search term is associated with a plurality of entities; and
in response to the determination that the primary search term is associated with the plurality of entities, for each respective entity of the plurality of entities:
determining a metadata identifier for the respective entity, wherein the metadata identifier is unique among each of the plurality of entities other than the respective entity; and
generating a suggested search string comprising a plurality of search string elements, wherein the plurality of search string elements includes the primary search term, the entity, and the metadata identifier.

2. The method of claim 1, wherein determining the metadata identifier for the respective entity comprises:
receiving metadata for the entity, wherein the metadata comprises, for each respective metadata category, a metadata category and a category value; and
determining whether at least one category value of a respective metadata category for the entity is unique among category values for the respective metadata category of all other entities.

3. The method of claim 2, wherein in response to the determination that at least one category value of the respective metadata category for the entity is not unique among category values for the respective metadata category of all other entities, determining whether at least two category values of respective metadata categories for the entity are unique among two categories values for the respective metadata categories of all other entities.

4. The method of claim 1, further comprising:
retrieving historical suggested search string selections from a data structure;
determining a common format of the historical suggested search string selections; and
determining an order of the plurality of search string elements based on the determined common format of the suggested search string selections.

5. The method of claim 4, wherein the historical suggested search string selections are retrieved for a user profile.

6. The method of claim 5, wherein a user of the user profile initiated the received search query.

7. The method of claim 2, further comprising:
retrieving user profile data;
determining whether the user profile data matches any of the received metadata for the entity; and
in response to the determination that the user profile data matches any of the received metadata for the entity, including the matching user profile data in the plurality of the search string elements.

8. The method of claim 1, wherein the received search query is a voice query.

9. The method of claim 1, further comprising generating for audio output the suggested search string.

10. The method of claim 1, further comprising generating for display the suggested search string.

11. A system for applying behavioral-based parental controls for media assets, comprising control circuitry configured to:
identify a primary search term from a received search query;
determine whether the primary search term is associated with a plurality of entities; and
in response to the determination that the primary search term is associated with the plurality of entities, for each respective entity of the plurality of entities:
determine a metadata identifier for the respective entity, wherein the metadata identifier is unique among each of the plurality of entities other than the respective entity; and
generate a suggested search string comprising a plurality of search string elements, wherein the plurality of search string elements includes the primary search term, the entity, and the metadata identifier.

12. The system of claim 11, wherein the control circuitry is further configured, when determining the metadata identifier for the respective entity, to:
receive metadata for the entity, wherein the metadata comprises, for each respective metadata category, a metadata category and a category value; and
determine whether at least one category value of a respective metadata category for the entity is unique among category values for the respective metadata category of all other entities.

13. The system of claim 12, wherein the control circuitry is configured, when in response to the determination that at least one category value of the respective metadata category for the entity is not unique among category values for the respective metadata category of all other entities, to determine whether at least two category values of respective metadata categories for the entity are unique among two categories values for the respective metadata categories of all other entities.

14. The system of claim 11, wherein the control circuitry is further configured to:
retrieve historical suggested search string selections from a data structure;
determine a common format of the historical suggested search string selections; and
determine an order of the plurality of search string elements based on the determined common format of the suggested search string selections.

15. The system of claim 14, wherein the historical suggested search string selections are retrieved for a user profile.

16. The system of claim 15, wherein a user of the user profile initiated the received search query.

17. The system of claim 12, wherein the control circuitry is further configured to:
retrieve user profile data;
determine whether the user profile data matches any of the received metadata for the entity; and
in response to the determination that the user profile data matches any of the received metadata for the entity, include the matching user profile data in the plurality of the search string elements.

18. The system of claim 11, wherein the received search query is a voice query.

19. The system of claim 11, wherein the control circuitry is further configured to generate for audio output the suggested search string.

20. The system of claim 11, wherein the control circuitry is further configured to generate for display the suggested search string.

21-50. (canceled)
